(19) United States
(12) Patent Application Publication
(10) Pub. No.: US 2026/0287420 A1
(43) Pub. Date: Sep. 24, 2026

(54) TECHNIQUES FOR DETECTING ANOMALIES IN AUDIO RECORDINGS FOR PREDICTIVE MAINTENANCE

(71) Applicant: DISNEY ENTERPRISES, INC., Burbank, CA (US)

(72) Inventors: Sarah Josephine PAGANO, Winter Garden, FL (US); Amber Elizabeth PAULSEN, Winter Garden, FL (US); Jeremy EATON, Winter Garden, FL (US); David MACLEAN, Orlando, FL (US); Isabelle Victoria WANG, Granada Hills, CA (US)

(21) Appl. No.: 19/087,363

(22) Filed: Mar. 21, 2025

(51) Int. Cl. G01H 3/08; G10L 25/18; G10L 25/30; G10L 25/51

(52) U.S. Cl. CPC G01H 3/08; G10L 25/18; G10L 25/30; G10L 25/51

(57) ABSTRACT

A computer-implemented technique for detecting audio anomalies includes processing a first frequency representation of a first audio recording using a first trained machine learning model to generate a second frequency representation of at least one voice and a third frequency representation of at least one sound produced by an equipment; detecting, using a second trained machine learning model, an anomaly based on the third frequency representation; and transmitting an alert to at least one computing device based on the anomaly.

### BACKGROUND

### Field of the Various Embodiments

The various embodiments relate generally to computer science, artificial intelligence (AI) and machine learning, and predictive maintenance and, more specifically, to techniques for detecting anomalies in audio recordings for predictive maintenance.

### Description of the Related Art

Predictive maintenance involves monitoring the performance and condition of in-service equipment in order to estimate when maintenance should be performed on the equipment. By monitoring the performance and condition of in-service equipment, corrective maintenance on the equipment can be better planned with shorter and fewer pauses of service, in turn increasing the availability of the equipment.

In the context of amusement parks, one approach for predictive maintenance of equipment at amusement park attractions is for human operators to listen for unusual sounds being made by the equipment. The drawback of requiring operators to listen for unusual sounds is those operators may not hear unusual sounds at certain locations within an amusement park attraction. In addition, operators may not always understand which sounds are unusual, resulting in inconsistencies in identifying unusual sounds that could indicate the need for maintenance.

Few, if any, effective techniques currently exist for automatically detecting unusual sounds made by equipment at amusement park attractions. One challenge of detecting unusual sounds at amusement park attractions is those attractions are oftentimes in open air environments crowded with loud guests. As a result, the acoustic environment of in-service equipment at amusement park attractions is typically too noisy for conventional anomaly detection systems to correctly distinguish unusual sounds that are made by the in-service equipment from other noises, such as the voices of guests.

As the foregoing illustrates, what is needed in the art are more effective techniques for predictive maintenance.

### SUMMARY

One embodiment of the present disclosure sets forth a computer-implemented method for detecting audio anomalies. The method includes processing a first frequency representation of a first audio recording using a first trained machine learning model to generate a second frequency representation of at least one voice and a third frequency representation of at least one sound produced by an equipment. The method further includes detecting, using a second trained machine learning model, an anomaly based on the third frequency representation. In addition, the method includes transmitting an alert to at least one computing device based on the anomaly.

At least one technical advantage of the disclosed techniques relative to the prior art is that the disclosed techniques filter out noises, such as voices, from audio recordings of in-service equipment, without removing mechanical sound signals that are used for anomaly detection to determine whether the in-service equipment requires maintenance. The disclosed techniques also utilize scientific microphones that are covered by wind filters to record audio of in-service equipment, allowing for greater sensitivity to a wider range of audio frequencies and more accurate detection of anomalies. In addition, the disclosed techniques generate notifications of detected anomalies that include interpretable and informative visualizations, permitting timely diagnosis of mechanical issues that may otherwise have been overlooked. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 illustrates an exemplar wind filter for the scientific microphone of FIG. 1, according to various embodiments;

FIG. 5 is a more detailed illustration of the model trainer of FIG. 1, according to various embodiments;

FIG. 6 is a more detailed illustration of the audio recorder and the predictive maintenance application of FIG. 1, according to various embodiments;

FIG. 7 illustrates an exemplar visualization of reconstruction error determined using the autoencoder model of FIG. 1, according to various embodiments;

FIG. 8 is a flow diagram of method steps for training a voice filtering model and an autoencoder model, according to various embodiments; and

FIG. 9 is a flow diagram of method steps for detecting anomalies from audio of in-service equipment, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### System Overview

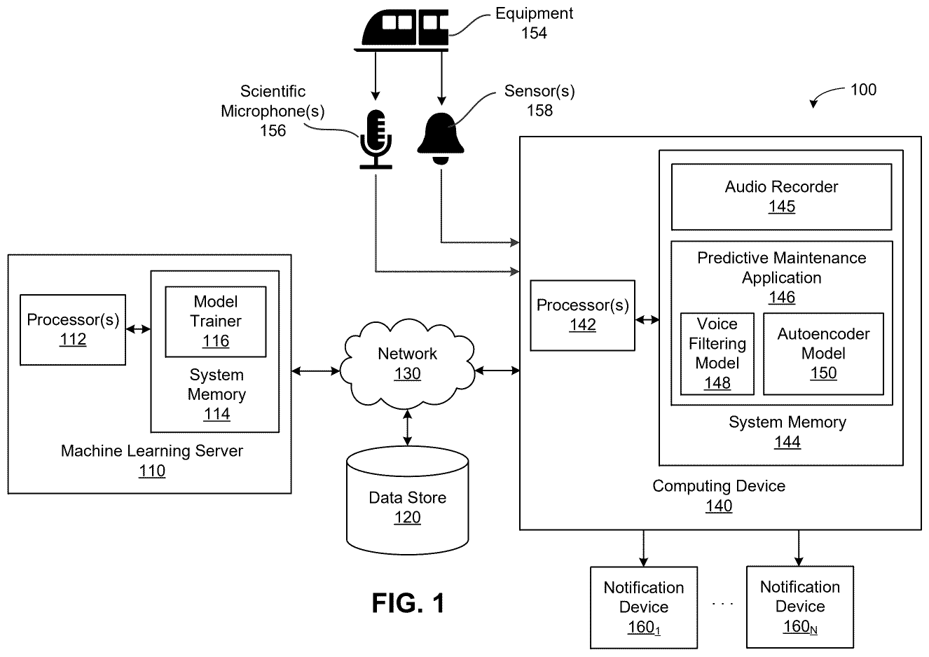

FIG. 1 illustrates a block diagram of a computer-based system 100 configured to implement one or more aspects of at least one embodiment. As shown, the system 100 includes, without limitation, a machine learning server 110, a data store 120, and a computing device 140 in communication over a network 130, which can include a wide area network (WAN) such as the Internet, a local area network (LAN), a cellular network, and/or any other suitable network or networks.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor(s) 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

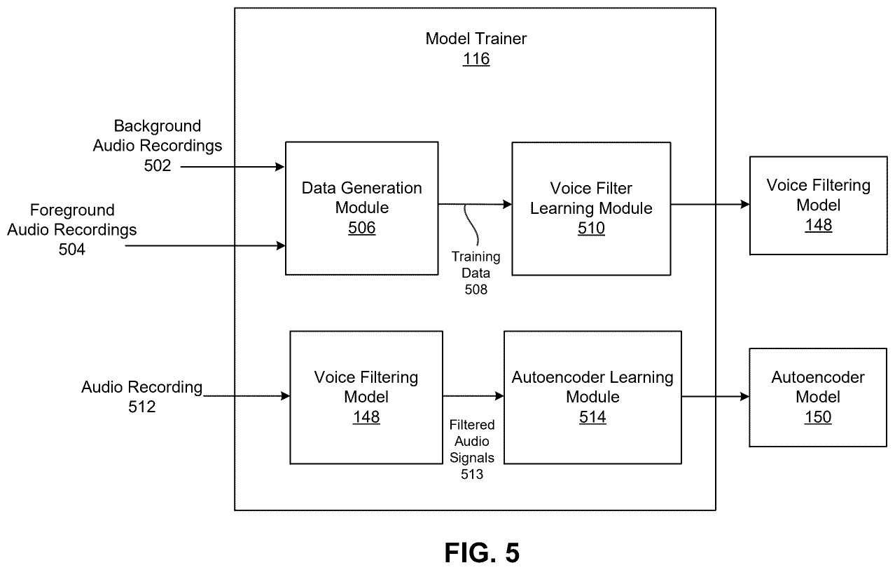

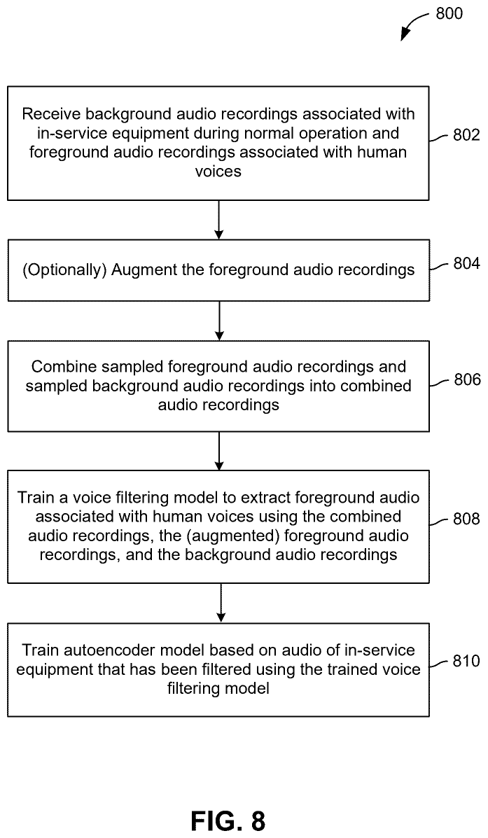

In some embodiments, the model trainer 116 is configured to train one or more machine learning models, including (1) a voice filtering model 148 that is trained to filter out human voices from frequency representations of audio recordings, and (2) an autoencoder model 150 that is used to detect anomalies in frequency representations of audio recordings from which voices have been filtered out. Techniques for training the voice filtering model 148 and the autoencoder model 150 are discussed in greater detail below in conjunction with FIGS. 5 and 8. Training data and/or trained machine learning models, including the voice filtering model 148 and the autoencoder model 150, can be stored in the data store 120, or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

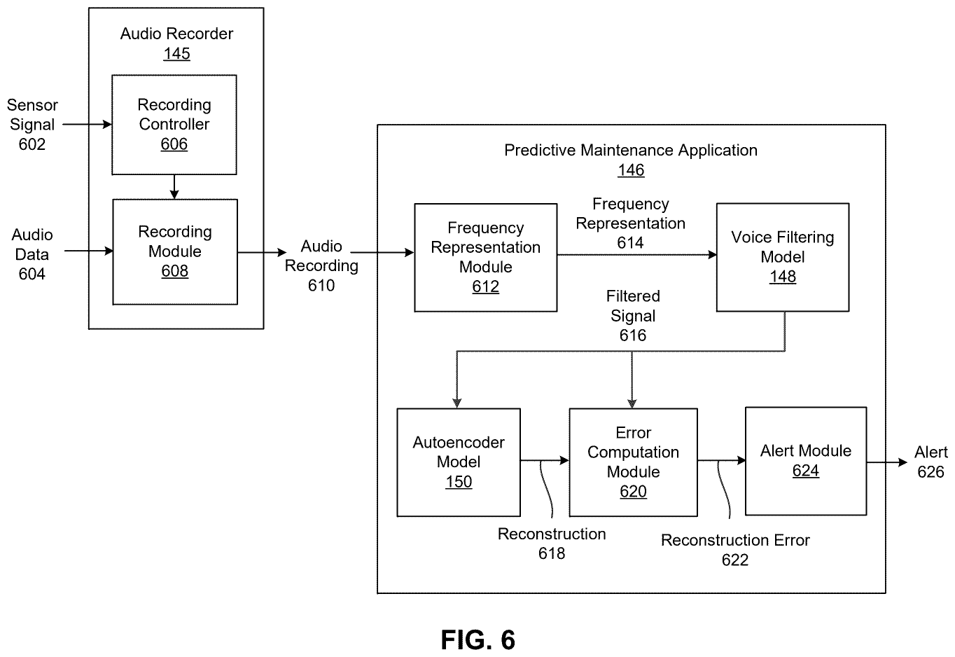

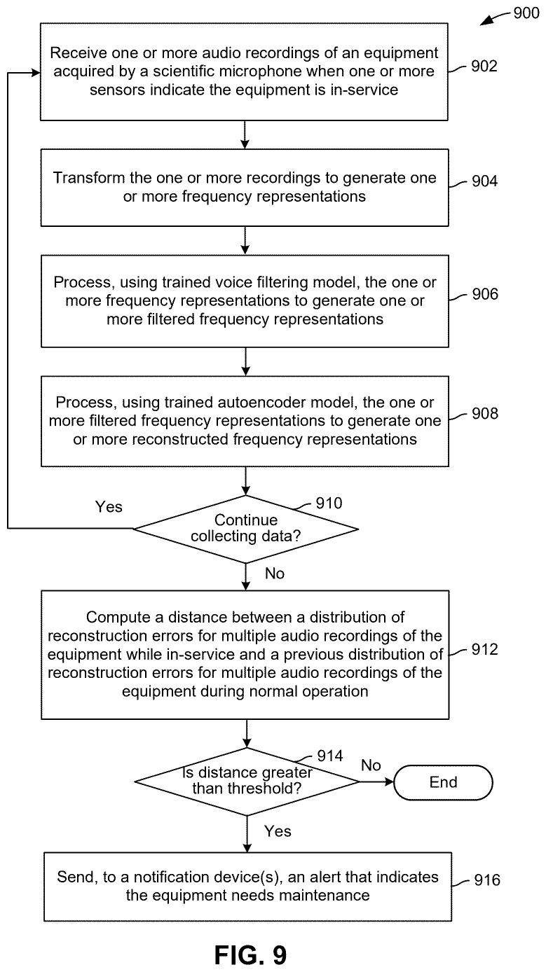

As shown, an audio recorder 145 and a predictive maintenance application 146 that uses the trained voice filtering model 148 and the trained autoencoder model 150 are stored in a system memory 144, and execute on processor(s) 142, of the computing device 140. In some embodiments, the system memory 144 and the processor(s) 142 can be similar to the system memory 114 and the processor(s) 112, respectively, of the machine learning server 110, described above. The audio recorder 145 is an application that uses audio data acquired by one or more scientific microphones 156 to generate audio recordings for times that sensor(s) 158 indicate that equipment 154 is or was in service, as discussed in greater detail below in conjunction with FIGS. 6 and 9. The equipment 154 can be any mechanical, electromechanical, or pneumatic system, or a portion thereof that generates sound during operation. For example, in the amusement park context, the equipment 154 could be part of an amusement park attraction. In such cases, the equipment 154 could be a ride (e.g., roller coaster, train, tram, etc.), mechanical system (e.g., track system, hydraulic or pneumatic system, conveyor system, etc.), animatronic, speaker system, etc., or a portion thereof (e.g., a ride switch, track switch, actuator, motor, etc.). As a specific example, in the case of a track switch for a ride, the audio recorder 145 could generate an audio recording from audio data acquired by a scientific microphone 156 that is pointed at the track switch when sensor data acquired by a sensor 158 indicates that the track switch is moving or has moved. Then, the audio recordings can be stored in the data store 120, or elsewhere. In some embodiments, audio data can be acquired by scientific microphone(s) 156 that are constantly recording, and audio files storing the acquired audio data can, contemporaneously or at a later time, be sliced by the audio recorder 145 based on sensor data to generate audio recordings corresponding to when the equipment is or was in service.

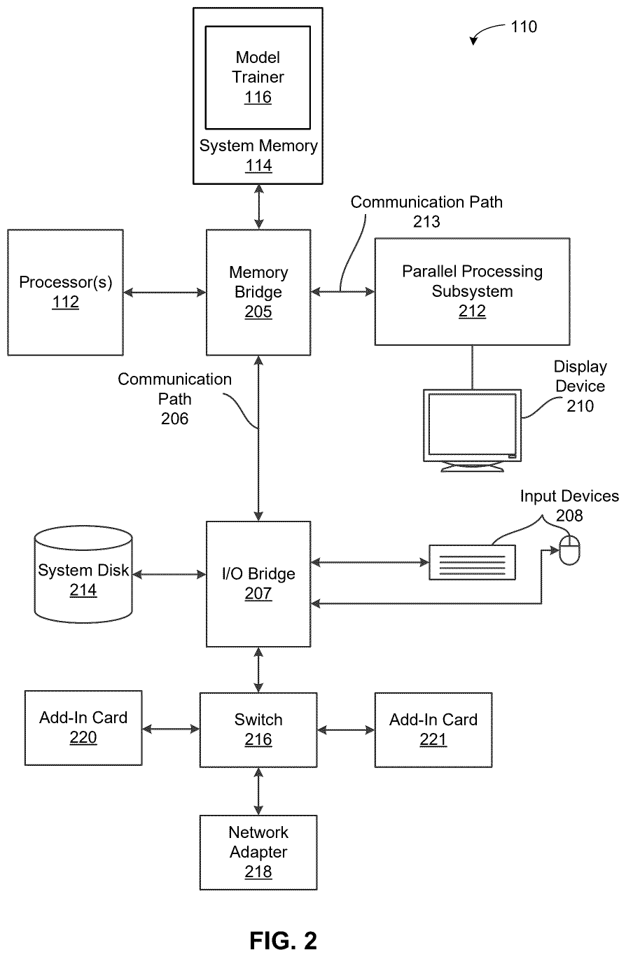

The scientific microphone(s) 156 are recording devices that convert sound waves into electrical signals. In some embodiments, the scientific microphone(s) 156 can have greater sensitivity to a wider range of audio frequencies than some other types of microphones. Additionally or alternatively, in some embodiments, other types of microphones can be used. Any suitable number of scientific microphones 156 can be used in some embodiments. For example, in some embodiments, one scientific microphone 156 can be pointed towards each portion of the equipment 154 that generates sounds of interest, such as a ride switch, a track switch, an actuator, a motor, or the like. In some embodiments, each of the scientific microphone(s) 156 can be covered by a wind filter, as discussed in greater detail below in conjunction with FIG. 2. In some embodiments, the scientific microphone(s) 156 can be mounted separate from the equipment 154 and/or on top of the equipment 154 (e.g., on a ride vehicle). The sensor(s) 158 are devices that detect changes in one or more aspects of the equipment 154. Any technically feasible sensor(s) 158 capable of acquiring sensor data that indicates an operating state of the equipment 154 can be used in some embodiments, such as one or more electrical or current sensors (e.g., Hall effect sensors, voltage and current sensors), position sensors (e.g., inductive/capacitive sensors, LIDAR (light detection and ranging) sensors), vibration sensors (e.g., accelerometers, piezoelectric sensors), pressure sensors (e.g., strain gauges, hydraulic/pneumatic pressure sensors), load or force sensors (e.g., torque sensors, load cells), etc. As described, sensor data acquired using the sensor(s) 158 is used by the audio recorder 145 to determine when the equipment 154 is or was in service. Returning to the example of a track switch, a sensor 158 could detect the position of a track, which can indicate a track switch is moving.

The predictive maintenance application 146 can use the trained voice filtering model 148 and the trained autoencoder model 150 to detect, in recordings generated by the audio recorder 145, anomalous sounds produced by the in-service equipment 154. The predictive maintenance application 146 can transmit alerts to notification devices 160_{1-N} (referred to herein collectively as notification devices 160 and individually as a notification device 160) when anomalous sounds are detected, as discussed in greater detail below in conjunction with FIGS. 6-7 and 9. Although shown as being included in the same computing device 140 as the audio recorder 145, in some embodiments, the predictive maintenance application 146 can execute on a different computing device than the audio recorder 145. For example, in some embodiments, the audio recorder 145 can execute on an edge device that is closer to the scientific microphone(s) 156 and the sensor(s) 158 than a computing device on which the predictive maintenance application 146 executes.

Each notification device 160 can include any computing device that has a suitable wired or wireless connection to the computing device 140 for receiving alerts. The notification devices 160 can output alerts received from the computing device 140 to a user, such as an amusement park employee responsible for maintaining the equipment 154. In some embodiments, the notification devices 160 can display alerts (e.g., using text, icons, maps, images, other visual content, etc.) and/or audibly play alerts (e.g., using voice content, sound effects, etc.) received from the computing device 140. Example notification devices 160 include a hand-held/mobile device, a wearable device, a laptop machine, a desktop machine, a server machine, a digital kiosk, and/or the like.

FIG. 2 is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In various embodiments, the machine learning server 110 includes, without limitation, the processor(s) 112 and the system memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In some embodiments, the switch 216 is configured to provide connections between the I/O bridge 207 and other components of the machine learning server 110, such as a network adapter 218 and various add-in cards 220 and 221.

In some embodiments, the I/O bridge 207 is coupled to a system disk 214 that may be configured to store content and applications and data for use by processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor(s) 112 and other connection circuitry on a single chip to form a system on a chip (SoC).

In some embodiments, the processor(s) 112 includes the primary processor of machine learning server 110, controlling and coordinating operations of other system components. In some embodiments, the processor(s) 112 issue commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, the system memory 114 could be connected to the processor(s) 112 directly rather than through the memory bridge 205, and other devices may communicate with the system memory 114 via the memory bridge 205 and the processor(s) 112. In other embodiments, the parallel processing subsystem 212 may be connected to the I/O bridge 207 or directly to the processor(s) 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. For example, the parallel processing subsystem 212 may be implemented as a virtualized parallel processing subsystem in at least one embodiment. As a specific example, the parallel processing subsystem 212 may be implemented as virtual graphics processing unit(s) (vGPU(s)) that render graphics on a virtual machine(s) (VM(s)) executing on server machine(s) whose GPU(s) and other physical resources are shared across one or more VMs.

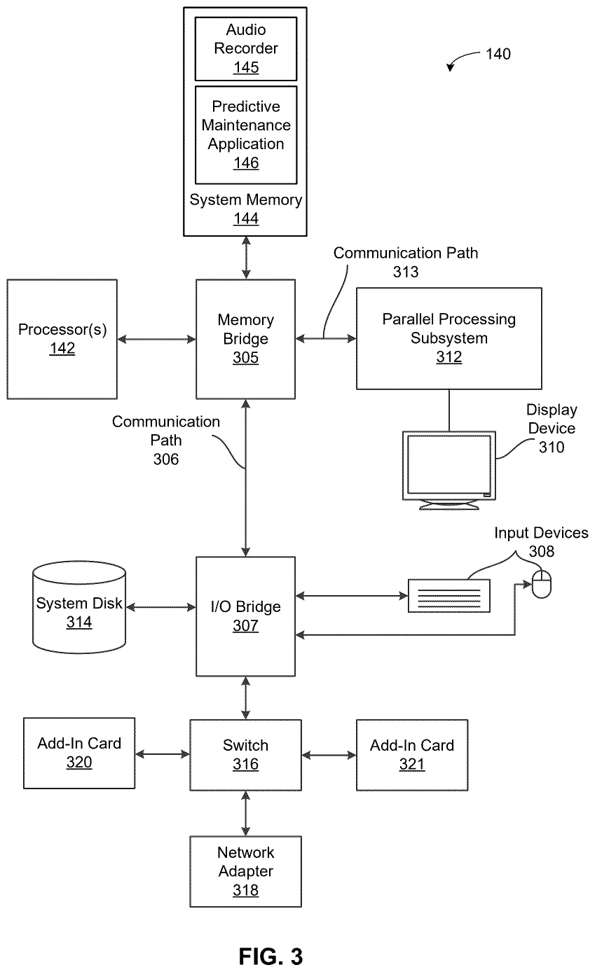

FIG. 3 is a more detailed illustration of the computing device 140 of FIG. 1, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network.

In various embodiments, the computing device 140 includes, without limitation, the processor(s) 142 and the system memory 144 coupled to a parallel processing subsystem 312 via a memory bridge 305 and a communication path 313. The memory bridge 305 is further coupled to an I/O bridge 307 via a communication path 306, and the I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, the computing device 140 may not include the input devices 308, but may receive equivalent input information by receiving commands (e.g., responsive to one or more inputs from a remote computing device) in the form of messages transmitted over a network and received via the network adapter 318. In some embodiments, the switch 316 is configured to provide connections between the I/O bridge 307 and other components of the computing device 140, such as a network adapter 318 and various add-in cards 320 and 321.

In some embodiments, the I/O bridge 307 is coupled to a system disk 314 that may be configured to store content and applications and data for use by the processor(s) 142 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, the communication paths 306 and 313, as well as other communication paths within the computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more PPUs, also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the audio recorder 145 and the predictive maintenance application 146. Although described herein primarily with respect to the audio recorder 145 and the predictive maintenance application 146, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with the processor(s) 142 and other connection circuitry on a single chip to form a SoC.

In some embodiments, the processor(s) 142 includes the primary processor of the computing device 140, controlling and coordinating operations of other system components. In some embodiments, the processor(s) 142 issue commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, the system memory 144 could be connected to the processor(s) 142 directly rather than through the memory bridge 305, and other devices may communicate with the system memory 144 via the memory bridge 305 and the processor(s) 142. In other embodiments, the parallel processing subsystem 312 may be connected to the I/O bridge 307 or directly to the processor(s) 142, rather than to the memory bridge 305. In still other embodiments, the I/O bridge 307 and the memory bridge 305 may be integrated into a single chip instead of existing as one or more discrete devices. In certain embodiments, one or more components shown in FIG. 3 may not be present. For example, the switch 316 could be eliminated, and the network adapter 318 and the add-in cards 320, 321 would connect directly to the I/O bridge 307. Lastly, in certain embodiments, one or more components shown in FIG. 3 may be implemented as virtualized resources in a virtual computing environment, such as a cloud computing environment. For example, the parallel processing subsystem 312 may be implemented as a virtualized parallel processing subsystem in at least one embodiment. As a specific example, the parallel processing subsystem 312 may be implemented as virtual graphics processing unit(s) (vGPU(s)) that render graphics on a virtual machine(s) (VM(s)) executing on server machine(s) whose GPU(s) and other physical resources are shared across one or more VMs.

### Detecting Anomalies in Audio Recordings for Predictive Maintenance

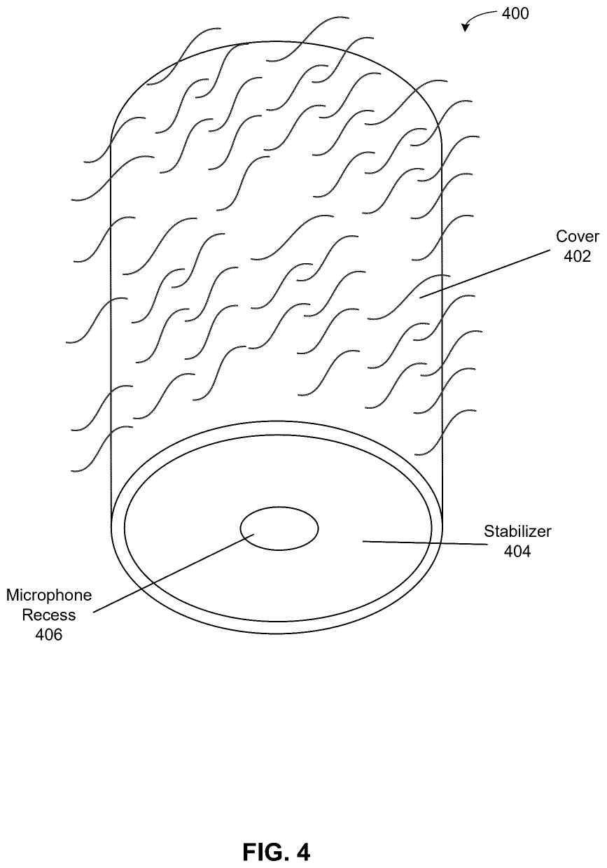

FIG. 4 illustrates an exemplar wind filter for the scientific microphone 156 of FIG. 1, according to various embodiments. As shown, a wind filter 400 includes, without limitation, a cover 402 and a stabilizer 404. The stabilizer 404 includes a microphone recess 406, into which a scientific microphone (e.g., a scientific microphone 156) can be inserted and held in place by the stabilizer 404.

The cover 402 is used to prevent wind from reaching the scientific microphone inserted into the microphone recess 406, thereby reducing or eliminating wind noises that would otherwise be captured by the scientific microphone. Illustratively, the cover 402 includes a cylinder and a fuzzy material disposed on the cylinder. In some embodiments, the cover 402 can be constructed from any technically feasible material or materials and have any suitable shape to prevent wind from reaching a scientific microphone that is at least partially surrounded by the cover. For example, in some embodiments, the cover 402 can include (1) a cylinder constructed from cardboard, plastic, wood, metal, and/or the like; and (2) fur or another fuzzy material that includes natural and/or synthetic fibers (e.g., polyester, cotton, felt, wool, acrylic, modacrylic, fleece, etc. fibers) and is affixed to an outside surface of the cylinder to help block wind sounds from reaching the scientific microphone housed inside the cover 402.

The stabilizer 404 is disposed within the cover 402. The stabilizer 404 is used to secure a scientific microphone that has been inserted into the microphone recess 406, preventing displacement of the scientific microphone relative to the cover 402 that could, e.g., cause the cover 402 to hit the scientific microphone. In some embodiments, the stabilizer 404 can have any technically feasible shape and be constructed from any suitable material or materials, such as foam, rubber, plastic, silicone, and/or a combination thereof. Further, the stabilizer 404 can be coupled to the cover 402 in any technically feasible manner, such as via an adhesive, fasteners, interlocking components, and/or a combination thereof.

FIG. 5 is a more detailed illustration of the model trainer 116 of FIG. 1, according to various embodiments. As shown, the model trainer 116 includes, without limitation, a data generation module 506, a voice filter learning module 510, the voice filtering model 148, and an autoencoder learning module 514. In operation, the model trainer 116 receives labeled audio recordings associated with in-service equipment during normal operation and without human voices, shown as background audio recordings 502, and audio associated with human voices, shown as foreground audio recordings 504. The data generation module 506 generates, from the background audio recordings 502 and foreground audio recordings 504, training data 508 that the voice filter learning module 510 uses to train the voice filtering model 148. Once trained, the voice filtering model 148 is used to filter voices in additional audio recordings 512 of the in-service equipment during normal operation to generate filtered audio signals 513. The filtered audio signals 513 are used by the autoencoder learning module 514 as training data to train the autoencoder model 150.

As described, the data generation module 506 receives the background audio recordings 502 and the foreground audio recordings 504 as input, and the data generation module 506 generates training data 508 that is used to train the voice filtering model 148. The background audio recordings 502 include labeled audio recordings associated with in-service equipment during normal operation and without human voices. When training the voice filtering model 148 and the autoencoder 150 to detect anomalies in audio acquired by a particular scientific microphone, the background audio recordings 502 can be acquired using the same scientific microphone, such as the same scientific microphone covered by a wind filter as described above in conjunction with FIG. 4. The background audio recordings 502 are labeled as belonging to the background, either in the background audio recordings 502 that are received by the model trainer 116 or by the data generation module 506 after the background audio recordings 502 have been received. The foreground audio recordings 504 include audio associated with human voices, such as screaming and other emotive voices, speaking voices, laughing voices, etc. For example, the foreground audio recordings 504 can be obtained from a publicly available library of human voice recordings. The foreground audio recordings 504 are labeled as belonging to the foreground, either in the foreground audio recordings 504 that are received by the model trainer 116 or by the data generation module 506 after the foreground audio recordings 504 have been received.

To generate the training data 508, the data generation module 506 randomly samples foreground audio recordings 504 and layers the sampled foreground audio recordings 504 on top of randomly sampled background audio recordings 502, thereby generating combined audio recordings that include audio data from the sampled foreground audio recordings 504 and audio data from the sampled background audio recordings 502. In some embodiments, the data generation module 506 can, optionally, first augment the foreground audio recordings 504 to generate augmented data that is used to generate the combined audio recordings, described above, and is also included, along with the background audio recordings 502, the foreground audio recordings 504, and the combined audio recordings, in the training data 508. Any suitable data augmentation can be performed in some embodiments, such as elongating the duration of the foreground audio recordings 504, changing the volume (in decibels) of the foreground audio recordings 504, changing the pitch of voices in the foreground audio recordings 504, and/or the like.

The voice filtering model 148 is a machine learning model that takes as input a frequency representation of audio and outputs frequency representations of background audio and foreground audio. The frequency representation of audio that is input into the voice filtering model 148 can be generated in any technically feasible manner in some embodiments, such as by the voice filter learning module 510 performing a Fourier transform that converts the audio into a frequency representation based on constituent frequencies in the audio. In some embodiments, the frequency representation can include values on a mel scale instead of a linear scale. Any technically feasible machine learning model, such as an artificial neural network, can be used as the voice filtering model 148 in some embodiments. For example, in some embodiments, the voice filtering model 148 can be a convolutional neural network (CNN), such as a CNN having a U-Net architecture. Alternatively or additionally, in some embodiments, any technically feasible audio filtering technique, such as a spectrum filter, can be used in conjunction with or in lieu of the voice filtering model 148.

The voice filter learning module 510 trains the voice filtering model 148 to extract foreground audio associated with human voices based on the training data 508 generated by the data generation module 506. As described, in some embodiments, the training data 508 can include (augmented) audio recordings of human voices that are labeled as foreground, audio recordings of the in-service equipment during normal operation that are labeled as background, and combinations of the (augmented) audio recording of human voices and audio recordings of in-service equipment. In such cases, the voice filter learning module 510 can convert the audio recordings into frequency representations and train the voice filtering model 148 using frequency representations of the combined audio recordings as input into the voice filtering model 148 and foreground and background frequency representations of the foreground and background audio recordings, respectively, as the expected output of the voice filtering model 148. Any technically feasible training technique can be applied to train an untrained model (e.g., a randomly initialized model) to generate the voice filtering model 148 in some embodiments, such as backpropagation with gradient descent, or a variation thereof, that minimizes a loss that is computed based on a difference between outputs of the voice filtering model 148 being trained and expected outputs from the training data 508.

Although described herein primarily with respect to the voice filtering model 148, in some embodiments, any number of audio filtering models that filter out any suitable sounds can be trained in a similar manner. For example, in some embodiments, another audio filtering model can be trained to filter out music from an input frequency representation. Alternatively, in some embodiments, the voice filtering model 148 can be trained to take as input a frequency representation of audio and output a foreground frequency representation of audio associated with human voices and a background frequency representation of other audio, including audio associated with an in-service equipment and audio associated with music. As a further example, in some embodiments, another audio filtering model can be trained to filter out animal noises from an input frequency representation. As yet another example, in some embodiments, another audio filtering model can be trained to filter out weather noises, such as rain, thunder, wind, etc., from an input frequency representation.

The autoencoder model 150 is a machine learning model that takes as input a frequency representation of audio and outputs a reconstruction of the input frequency representation. In some embodiments, the autoencoder model 150 includes an encoder that maps input data into a lower-dimensional latent representation and a decoder that maps the latent representation back to the original input space. Although described herein primarily with respect to the autoencoder model 150 as a reference example, any technically feasible anomaly detection model or technique can be used in some embodiments to identify anomalous mechanical sounds produced by in-service equipment. For example, instead of the autoencoder model 150, a CNN can be used in some embodiments.

The autoencoder learning module 514 trains the autoencoder model 150 based on the filtered audio signals 513 that include audio of in-service equipment that has been filtered using the trained voice filtering model 148. In some embodiments, the autoencoder learning module 514 can also add padding that includes silence (e.g., 0-padding) to the audio of in-service equipment so that all (filtered) inputs into the autoencoder model 150 have a standard duration. Any technically feasible training technique can be applied to train an untrained autoencoder (e.g., a randomly initialized autoencoder) to generate the autoencoder model 150 in some embodiments, such as backpropagation with gradient descent, or a variation thereof, that minimizes a reconstruction loss that is the difference between data input into the autoencoder model 150 and reconstructed data that is output by the autoencoder model 150.

FIG. 6 is a more detailed illustration of the audio recorder 145 and the predictive maintenance application 146 of FIG. 1, according to various embodiments. As shown, the audio recorder 145 includes, without limitation, a recording controller 606 and a recording module 608. The predictive maintenance application 146 includes, without limitation, a frequency representation module 612, the voice filtering model 148, the autoencoder model 150, an error computation module 620, and an alert module 624. Although shown as being included in the predictive maintenance application 146 for illustrative purposes, in some embodiments, the voice filtering model 148 and/or the autoencoder model 150 can execute elsewhere. For example, in some embodiments, the voice filtering model 148 can be separated from the autoencoder model 150 such that output from the voice filtering model 148 is transferred, as files or as streams or other mechanisms, to the autoencoder model 150 on a separate compute platform (physical, virtual, or cloud). As a specific example, audio could be recorded on one device, voice filtering could be performed on another device, and anomaly detection could be performed on yet another device. As another example, in some embodiments, one or more of the voice filtering model 148 and/or the autoencoder model 150 can execute in a cloud computing environment and be accessed by the predictive maintenance application 146 via, e.g., an application programming interface (API).

In operation, the audio recorder 145 receives one or more sensor signals, shown as sensor signal 602, from the sensor(s) 158 and audio data, shown as audio data 604, acquired using the scientific microphone(s) 156. Although described herein primarily with respect to a single sensor signal 602 and audio data 604 for illustrative purposes, in some embodiments, techniques disclosed herein can be applied to process any number of sensor signals and audio data acquired using any number of sensors and microphones, respectively. In some embodiments, the audio data 604 can include audio data that is acquired in real time or audio data that has been acquired and stored (e.g., in one or more files) for later processing. Similarly, in some embodiments, the sensor signal 602 can be sensor data that is acquired in real time or sensor data that has been acquired and stored for later processing. Given such inputs, the audio recorder 145 can generate one or more audio recordings, shown as audio recording 610.

The recording controller 606 is a module of the audio recorder 145 that processes the sensor signal 602 and determines how to generate audio recordings (e.g., audio recording 610) from the audio data 604. In some embodiments, the recording controller 606 can determine to generate audio recordings based on the sensor signal 602 indicating that an equipment being monitored is or was in service. Returning to the example of a track switch, the sensor signal 602 could be a signal from a sensor that indicates the sensed position of a track. In such cases, the recording controller 606 can determine to generate an audio recording for a period of time when the sensed position indicates that the track switch is moving, and the recording controller 606 can control the recorder module 608 to generate an audio recording from the audio data 604 corresponding to the movement of the track switch. As described, in some embodiments, audio data can be acquired by scientific microphone(s) 156 that are constantly recording. Based on sensor data that is acquired along with the audio data, the recording controller 606 can determine, contemporaneously or at a later time, how to slice the audio data to generate audio recordings corresponding to when the equipment is or was in service.

Based on control by the recording controller 606, the recorder module 608 generates one or more audio recordings, shown as an audio recording 610, from the audio data 604. Each of the audio recording(s) can be stored in any technically feasible format, such as a WAV (Waveform Audio File Format) file, an MP3 (MPEG-1 Audio Layer 3) file, or WMA (Windows Media Audio) file. Returning to the example of a track switch, the recording controller 606 could control the recorder module 608 to generate audio recordings from the audio data 604 for periods of times when the track switch is or was moving, and the audio recording for each time the track switch moves could last a few seconds (e.g., 5-8 seconds). Audio recordings (e.g., audio recording 610) generated by the recording module 608 can be stored in any technically feasible manner, such as in the data store 120 or elsewhere.

In operation, the predictive maintenance application 146 receives the audio recording 610 generated by the audio recorder 145, the frequency representation module 612 converts the audio recording 610 into a frequency representation 614, the voice filtering model 148 processes the frequency representation 614 to generate a filtered signal 616 that is a frequency representation from which human voices have been removed, the autoencoder model 150 processes the filtered signal 616 to generate a reconstruction 618 of the filtered signal 616, the error computation module 620 computes a reconstruction error 622 that is a difference between the filtered signal 616 and the reconstruction 618, and the alert module 624 generates an alert 626 when the reconstruction errors over a period of time satisfy a threshold for the alert 626.

As described, the frequency representation module 612 converts the audio recording 610 into a frequency representation 614. The frequency representation module 612 can perform any technically feasible transformation to convert the audio recording 610 into the frequency representation 614. In some embodiments, the frequency representation module 612 can perform a Fourier transform on the audio recording 610 to generate the frequency representation 614. In such cases, the Fourier transform can convert the audio recording 610 into the frequency representation 614 based on constituent frequencies in the audio recording 610, essentially showing how much of each frequency is present in the audio recording 610. In some embodiments, the frequency representation 614 can include values on a mel scale, similar to the description above in conjunction with FIG. 5. In some embodiments, the predictive maintenance application 146 can pad the audio recording 610 with silence (e.g., 0-padded) to generate an audio recording having a standard duration, and the padded audio recording can then be converted to a frequency representation. Experience has shown that some anomaly detection models, such as the autoencoder model 150, can perform better when all audio recordings being processed are of a standard duration.

The voice filtering model 148 is a trained machine learning model that takes the frequency representation 614 as input and generates the filtered signal 616. In some embodiments, the filtered signal 616 can be a frequency representation, such as frequency values on a mel scale, of audio with human voices removed. As described, the voice filtering model 148 can include any technically feasible architecture, such as a CNN having a U-Net architecture. In some embodiments, the voice filtering model 148 can be trained to distinguish between background signals associated with the equipment in-service and foreground signals associated with human voices, as described above in conjunction with FIG. 5. In such cases, the filtered signal 616 can be a frequency representation of a background signal associated with the equipment in-service that is extracted from the frequency representation 614, and the voice filtering model 148 can also output a frequency representation of a foreground signal associated with human voices (not shown) that is extracted from the frequency representation 614. The frequency representation of the foreground signal is not used by the predictive maintenance application 146 and can be discarded.

In some embodiments, the voice filtering model 148 or one or more other models or modules can be used to filter out signals besides human voices, such as animal audio signals or non-mechanical background audio signals (e.g., music or weather). For example, in some embodiments, the voice filtering model 148 or another machine learning model can be trained to filter out animal noises. As another example, in some embodiments, another machine learning model can be trained to filter out audio from rain and/or other weather conditions. As another example, in some embodiments, a spectrum filter can be used to filter out certain frequencies of audio that correspond to rain and/or other weather conditions.

The autoencoder model 150 is a machine learning model that is trained to reconstruct frequency representations of previously filtered background audio signals of the in-service equipment during normal operation, as described above in conjunction with FIG. 5. Given the filtered signal 616 that is a new frequency representation of the audio recording 610 without human voices (and optionally other audio signals), the autoencoder model 150 outputs a reconstructed frequency representation, shown as the reconstruction 618. The reconstruction 618 will better match the filtered signal 616 when the filtered signal 616 represents an audio of mechanical sounds made by in-service equipment during normal operation, and vice versa when the filtered signal 616 represents an audio recording of anomalous sounds made by in-service equipment that may require maintenance. Notably, because human voices (and optionally other noises) have been filtered out using the voice filtering model 148 (and/or other audio filtering models or techniques), those human voices (and optionally other noises) will not be mistaken for anomalous sounds made by the in-service equipment.

The error computation module 620 computes a reconstruction error 622 as a difference between the filtered signal 616 and the reconstruction 618. For example, in some embodiments, the error computation module 620 can subtract values of the reconstruction 618 from values of the filtered signal 616 to compute the reconstruction error 622.

The alert module 624 identifies anomalies based on reconstruction errors computed by the error computation module 620 and generates alerts, shown as alert 626, when anomalies are identified. In some embodiments, the alert module 624 can identify an anomaly when the distance between (1) a distribution of reconstruction errors for audio recordings of the in-service equipment during a period of time (e.g., over the course of a day), and (2) a baseline distribution of reconstruction errors for a number of audio recordings of the equipment during a previous period of time when the equipment was operating normally (e.g., during a previous day when the autoencoder model 150 was being trained), is greater than a threshold. In such cases, any suitable period of time can be used, such as one or more seconds, one or more minutes, one or more hours, one or more days, etc. In addition, the alert module 624 can compute the distance using any technically feasible distance metric, such as the Wasserstein distance metric. Any distance that is greater than the threshold triggers an alert to notify one or more users that an anomaly has been detected. In some embodiments, multiple predefined thresholds can be used to trigger different levels of alerts, such as lower-level alerts that are less urgent and higher-level alerts that are more urgent. In such cases, the different levels of alerts can also be transmitted in different formats and/or via different transmission channels.

The alert 626 can be in any suitable format and be transmitted to one or more of the notification devices 160 in any technically feasible manner. For example, in some embodiments, the alert 626 can be a text message or push notification that is sent to one or more wireless devices, such as mobile phone(s) and/or tablet device(s). As another example, in some embodiments, the alert 626 can be a message to an application running on one or more wireless devices. As yet another example, in some embodiments, the alert 626 can be an email message. In some embodiments, alerts and/or reconstruction errors can also be stored, such as in a database, for later analysis. In some embodiments, the alert 626 can include a visual representation of the identified anomaly, such as a graph of the reconstruction error. In some embodiments, the audio recording(s) that triggered the alert 626 can be included in or sent along with the alert 626.

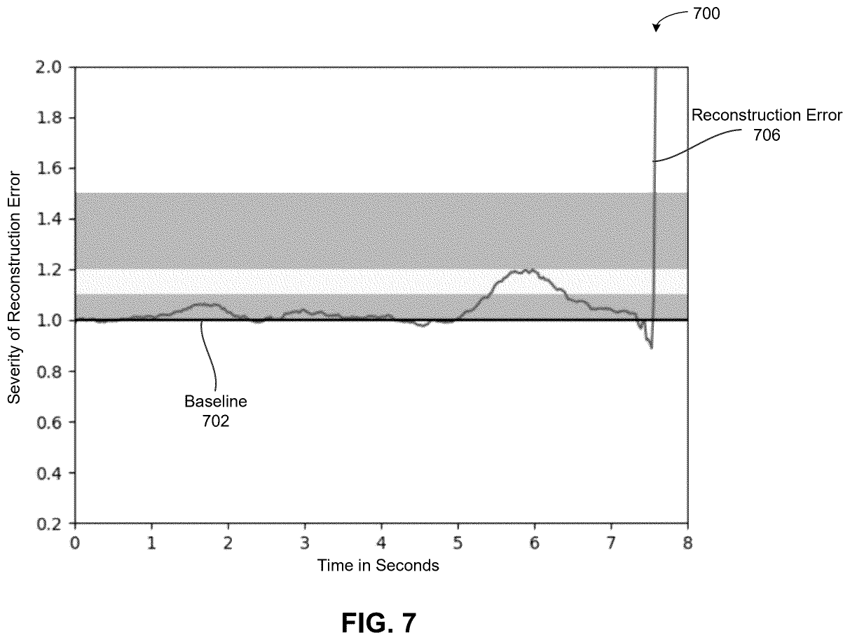

FIG. 7 illustrates an exemplar visualization of reconstruction error determined using the autoencoder model 150 of FIG. 1, according to various embodiments. As shown, a graph 700 can be generated (by, e.g., the alert module 624) to represent a relative reconstruction error over time for an entire day at a particular track switch. In some embodiments, the alert module 624 can generate the graph 700 of reconstruction error over time for a day after detecting an anomaly based on the distance between a distribution of reconstruction errors for the day and a baseline distribution of reconstruction errors from when the equipment was operating normally, as described above in conjunction with FIG. 6.

In the example of FIG. 7, the track switch moves for 8 seconds, and the reconstruction error has been averaged over the 8 second period throughout the day. Illustratively, the relative reconstruction error for the last 4 seconds of the track switch movement is significantly above a baseline 702, which indicates that something is wrong with the track switch, specifically with the last 4 seconds of movement of the track switch. The predictive maintenance application 146 can generate and transmit an alert (e.g., alert 626) that includes one or more visualizations, such as the graph 700, as described above in conjunction with FIG. 6.

FIG. 8 is a flow diagram of method steps for training a voice filtering model and an autoencoder model, according to various embodiments. Although the method steps are described in conjunction with the systems of FIGS. 1-6, persons skilled in the art will understand that any system configured to perform the method steps in any order falls within the scope of the present embodiments.

As shown, a method 800 begins at step 802, where the model trainer 116 receives background audio recordings associated with in-service equipment during normal operation and foreground audio recordings associated with human voices. As described, the background audio recordings can include labeled audio recordings associated with in-service equipment during normal operation and without human voices. In some embodiments, the background audio recordings can be acquired using the same scientific microphone for which the voice filtering model 148 and the autoencoder 150 are being trained, such as the same scientific microphone covered by a wind filter as described above in conjunction with FIG. 4. The same scientific microphone can also be in the same position and orientation as during normal operation/monitoring. The foreground audio recordings include audio associated with human voices, such as screaming and other emotive voices, speaking voices, laughing voices, etc. For example, the foreground audio recordings can be obtained from a publicly available library of human voice recordings.

At step 804, the model trainer 116 optionally augments the foreground audio recordings. Any suitable data augmentation can be performed in some embodiments, such as elongating the duration of the foreground audio recordings, changing the volume (in decibels) of the foreground audio recordings, changing the pitch of voices in the foreground audio recordings, and/or the like. No data augmentation may be performed in some other embodiments.

At step 806, the model trainer 116 combines sampled foreground audio recordings and sampled background audio recordings into combined audio recordings. As described, the model trainer 116 can randomly sample foreground audio recordings and layer the sampled foreground audio recordings on top of randomly sampled background audio recordings, thereby generating combined audio recordings that include audio data from the sampled foreground audio recordings and audio data from the sampled background audio recordings.

At step 808, the model trainer 116 trains a voice filtering model (e.g., voice filtering model 148) to extract foreground audio associated with human voices based on the combined audio recordings, the (augmented) foreground audio recordings, and the background audio recordings. As described, the voice filtering model can be a machine learning model that takes as input a frequency representation of audio and outputs frequency representations of background audio and foreground audio. The frequency representation of audio that is input into the voice filtering model can be generated in any technically feasible manner in some embodiments, such as by the model trainer 116 performing a Fourier transform that converts the audio into a frequency representation based on constituent frequencies in the audio. In some embodiments, the frequency representation can include values on a mel scale instead of a linear scale. Any technically feasible machine learning model, such as an artificial neural network, can be used as the voice filtering model in some embodiments. For example, in some embodiments, the voice filtering model can be a CNN, such as a CNN having a U-Net architecture. Alternatively or additionally, in some embodiments, any technically feasible audio filtering technique, such as a spectrum filter, can be used in conjunction with or in lieu of the voice filtering model. In some embodiments, the model trainer 116 trains the voice filtering model to extract foreground audio associated with human voices based on training data that includes the (augmented) audio recordings of human voices that are labeled as foreground, audio recordings of the in-service equipment during normal operation that are labeled as background, and combinations of the (augmented) audio recording of human voices and audio recordings of in-service equipment. In such cases, the model trainer 116 can convert the audio recordings into frequency representations and train the voice filtering model using frequency representations of the combined audio recordings as input into the voice filtering model and foreground and background frequency representations of the foreground and background audio recordings, respectively, as the expected output of the voice filtering model. Any technically feasible training technique can be applied to train the voice filtering model in some embodiments, such as backpropagation with gradient descent, or a variation thereof, to minimize a loss that is computed based on a difference between outputs of the voice filtering model being trained and expected outputs from the training data. In some embodiments, in addition to the voice filtering model, any number of other audio filtering models that filter out any suitable sounds can be trained in a similar manner. For example, in some embodiments, one or more other audio filtering models can be trained to filter out music, animal noises, weather noises, etc. from an input frequency representation.

At step 810, the model trainer 116 trains an autoencoder model (e.g., autoencoder model 150) based on audio of in-service equipment that has been filtered using the trained voice filtering model. As described, in some embodiments, the autoencoder model is a machine learning model that takes as input a frequency representation of audio and outputs a reconstruction of the input frequency representation. In such cases, the autoencoder can include an encoder that maps input data into a lower-dimensional latent representation and a decoder that maps the latent representation back to the original input space. Although described herein primarily with respect to an autoencoder model as a reference example, any technically feasible anomaly detection model (e.g., a CNN) or technique can be used in some embodiments to identify anomalous mechanical sounds produced by in-service equipment. The model trainer 116 trains the autoencoder model based on the filtered audio signals that include audio of in-service equipment that has been filtered using the trained voice filtering model. In some embodiments, the autoencoder learning module 514 can also add padding that includes silence (e.g., 0-padding) to the audio of in-service equipment so that all (filtered) inputs into the autoencoder model have a standard duration. Any technically feasible training technique can be applied to train the autoencoder model in some embodiments, such as backpropagation with gradient descent, or a variation thereof, to minimize a reconstruction loss that is the difference between data input into the autoencoder model and reconstructed data that is output by the autoencoder model.

FIG. 9 is a flow diagram of method steps for detecting anomalies from audio of in-service equipment, according to various embodiments. Although the method steps are described in conjunction with the systems of FIGS. 1-6, persons skilled in the art will understand that any system configured to perform the method steps in any order falls within the scope of the present embodiments.

As shown, a method 900 begins at step 902, where the predictive maintenance application 146 receives one or more audio recordings of an equipment acquired by a scientific microphone (e.g., a scientific microphone 156) when one or more sensors (e.g., one or more of sensors 158) indicate the equipment is in-service. As described, in some embodiments, the audio recorder 145 can process sensor signal(s) from the sensor(s) and determine when to generate audio recordings (e.g., audio recording 610) from audio data acquired using scientific microphone(s). In some embodiments, the audio recorder 145 can determine to generate audio recordings from audio data corresponding to times when the sensor signal(s) indicate that an equipment being monitored is or was in service, as described above in conjunction with FIGS. 1 and 6.

At step 904, the predictive maintenance application 146 transforms the one or more recordings to generate one or more frequency representations. As described, in some embodiments, the predictive maintenance application 146 can perform any technically feasible transformation to convert the audio recording(s) into frequency representation(s). In some embodiments, the predictive maintenance application 146 can perform a Fourier transform on the audio recording(s) to generate the frequency representation(s). In some embodiments, the frequency representation(s) can include values on a mel scale. In some embodiments, the predictive maintenance application 146 can pad the audio recording(s) with silence to generate audio recording(s) having a standard duration, and the padded audio recording(s) can then be converted to frequency representation(s). Experience has shown that some anomaly detection models, such as the autoencoder model 150, can perform better when all audio recordings being processed are of a standard duration.

At step 906, the predictive maintenance application 146 processes, using a trained voice filtering model (e.g., voice filtering model 148), the one or more frequency representations to generate one or more filtered frequency representations. In some embodiments, one or more other trained audio filtering models and/or techniques can also be applied, such as trained audio filtering models and/or techniques for filtering out music, animal sounds, weather noises, and/or the like, as described above in conjunction with FIGS. 5-6. In some embodiments, the voice filtering model can be trained, according to the method 800 described above in conjunction with FIG. 8, to distinguish between background signals associated with the equipment in-service, which are output as the filtered frequency representation(s), and foreground signals associated with human voices, which are output as other frequency representation(s) that can be discarded.

At step 908, the predictive maintenance application 146 processes, using a trained autoencoder model (e.g., autoencoder model 150), the one or more filtered frequency representations to generate one or more reconstructed frequency representations. As described, in some embodiments, the autoencoder model can be a machine learning model that is trained to reconstruct frequency representations of previously filtered background audio signals of the in-service equipment during normal operation. Given the filtered signal that is a new frequency representation of an audio recording without human voices (and optionally other audio signals), the autoencoder model outputs a reconstructed frequency representation.

At step 910, if the predictive maintenance application 146 determines to continue collecting data, then the method 900 returns to step 902, where the predictive maintenance application 146 receives one or more additional audio recordings of the equipment generated by the audio recorder 145. In some embodiments, the predictive maintenance application 146 can continue collecting data for any duration of time, such as one or more seconds, one or more minutes, one or more hours, one or more days, etc. For example, in some embodiments, the predictive maintenance application 146 can continue collecting data corresponding to times when the equipment is in service (e.g., during the daytime) and not collect data corresponding to times when the equipment is out of service (e.g., at nighttime).

If the predictive maintenance application 146 determines at step 910 not to continue collecting data, then the method 900 continues to step 912. At step 912, the predictive maintenance application 146 computes a distance between a distribution of reconstruction errors for multiple audio recordings of the equipment while in-service and a previous distribution of reconstruction errors for multiple audio recordings of the equipment during normal operation. As described, the reconstruction errors are differences between frequency representations input into the autoencoder model (e.g., autoencoder model 150) and reconstructions that are output by the autoencoder model. A reconstruction will better match an input frequency representation when the input frequency representation represents an audio of mechanical sounds made by in-service equipment during normal operation, and vice versa when the input frequency representation represents an audio recording of anomalous sounds made by in-service equipment that may require maintenance. Notably, because human voices (and optionally other noises) have been filtered out using audio filtering model(s) (and/or other audio filtering techniques), those human voices (and optionally other noises) will not be mistaken for anomalous sounds made by the in-service equipment. In some embodiments, the predictive maintenance application 146 can compute a distance between distributions of reconstruction errors over a period of time, such as a distance between (1) a distribution of reconstruction errors for audio recordings of the in-service equipment during a period of time (e.g., over the course of a day), and (2) a baseline distribution of reconstruction errors for a number of audio recordings of the equipment during a previous period of time when the equipment was operating normally (e.g., during a previous day when the autoencoder model was being trained). In such cases, any suitable period of time can be used, such as one or more seconds, one or more minutes, one or more hours, one or more days, etc. In addition, the predictive maintenance application 146 can compute the distance using any technically feasible distance metric, such as the Wasserstein distance metric.

At step 914, if the predictive maintenance application 146 determines that the distance is greater than a threshold, then at step 916, the predictive maintenance application 146 sends, to one or more notification devices (e.g., notification device(s) 160), an alert (e.g., alert 626) that indicates the equipment needs maintenance. As described, in some embodiments, multiple predefined thresholds can be used to trigger different levels of alerts, such as lower-level alerts that are less urgent and higher-level alerts that are more urgent. In such cases, the different levels of alerts can also be transmitted in different formats and/or via different transmission channels. In some embodiments, the alert can be transmitted to one or more notification devices (e.g., one or more of the notification devices 160) in any technically feasible manner. For example, in some embodiments, the alert can be a text message or push notification that is sent to one or more wireless devices, such as mobile phone(s) and/or tablet device(s). As another example, in some embodiments, the alert can be a message to an application running on one or more wireless devices. As yet another example, in some embodiments, the alert can be an email message. In some embodiments, alerts and/or reconstruction errors can also be stored, such as in a database, for later analysis. In some embodiments, the alert can include a visual representation of the identified anomaly, such as a graph of the reconstruction error (e.g., the graph 700 described above in conjunction with FIG. 7). In some embodiments, the audio recording(s) that triggered the alert can be included in or sent along with the alert.

On the other hand, if the predictive maintenance application 146 determines that the distance is not greater than a threshold at step 914, then the method 900 ends. Alternatively, the method 900 can return to step 902 in some embodiments.

In sum, techniques are disclosed for detecting anomalies in audio recordings of in-service equipment for use in predictive maintenance. In some embodiments, a scientific microphone connected to a computing device records audio of an equipment. The scientific microphone is covered by a wind filter that filters out audio signals associated with wind in the environment, and the scientific microphone is directed toward the equipment. One or more sensors detect when the equipment starts being in-service. Sounds that the equipment makes while in-service, which are recorded by the scientific microphone, are saved to audio recordings, such as audio recordings of sounds that are made for a few seconds each time the equipment moves. An anomaly detection application performs Fourier transforms, or similar techniques, on the audio recordings to transform the audio recordings to frequency representations. The anomaly detection application processes the frequency representations of the audio recordings using a voice filter to filter out human voices. The voice filter includes a machine learning model trained to take a frequency representation of an audio recording as input and distinguish between background signals associated with the equipment in-service and foreground signals associated with human voices. Silence can also be added to an audio recording to pad the length of the audio recording to a standard duration, and the padded audio recording can then be converted to a frequency representation that is input into the voice filter. Given frequency representations of audio recordings, the voice filter outputs background frequency representations of the audio recordings without human voices and foreground frequency representations of human voices that have been extracted from the audio recordings. In some embodiments, the same machine learning model or different machine learning model(s) can be trained and used to filter out other audio signals besides human voices, such as animal audio signals or non-mechanical background audio signals (e.g., music or weather). The anomaly detection application inputs the frequency representations of the audio recordings without human voices (and optionally other audio signals) into an anomaly detection model that is used to determine whether the frequency representations are anomalous, meaning the mechanical sounds associated with the frequency representations are not normal and the equipment may require maintenance. In some embodiments, the anomaly detection model includes an autoencoder model trained on frequency representations of previously filtered background audio signals of the equipment during normal operation. In such cases, given a new frequency representation of an audio recording without human voices (and optionally other audio signals), the autoencoder model outputs a reconstructed frequency representation that the anomaly detection application compares with the new frequency representation to compute a reconstruction error.

The anomaly detection application can identify an anomaly when the distance between (1) a distribution of reconstruction errors for a number of audio recordings of the in-service equipment, such as audio recordings that are made over the course of a day, and (2) a distribution of reconstruction errors for a number of audio recordings of the equipment during normal operation, such as audio recordings that were made over the course of a day during training of the autoencoder model, is greater than a predefined threshold. The distance can be computed using any technically feasible distance metric, such as the Wasserstein distance metric. Distances that are greater than a predefined threshold can trigger an alert to notify one or more users that anomalies have been detected. In some embodiments, the anomaly detection application generates visual representations of anomalies, such as graphs of the reconstruction error, and sends the visual representations with an alert to one or more users. Different levels of alert and/or different types of alerts (e.g., text message alerts, email alerts, etc.) can be sent in some embodiments, depending on the severity of detected anomalies. In some embodiments, the audio recording(s) that triggered the alert can be sent along with the alert.

At least one technical advantage of the disclosed techniques relative to the prior art is that the disclosed techniques filter out noises, such as voices, from audio recordings of in-service equipment, without removing mechanical sound signals that are used for anomaly detection to determine whether the in-service equipment requires maintenance. The disclosed techniques also utilize scientific microphones that are covered by wind filters to record audio of in-service equipment, allowing for greater sensitivity to a wider range of audio frequencies and more accurate detection of anomalies. In addition, the disclosed techniques generate notifications of detected anomalies that include interpretable and informative visualizations, permitting timely diagnosis of mechanical issues that may otherwise have been overlooked. These technical advantages represent one or more technological improvements over prior art approaches.
1. In some embodiments, a computer-implemented method for detecting audio anomalies comprises processing a first frequency representation of a first audio recording using a first trained machine learning model to generate a second frequency representation of at least one voice and a third frequency representation of at least one sound produced by an equipment, detecting, using a second trained machine learning model, an anomaly based on the third frequency representation, and transmitting an alert to at least one computing device based on the anomaly.
2. The computer-implemented method of clause 1, further comprising, in response to a signal from a sensor indicating that the equipment is or was in service, generating the first audio recording based on audio data acquired using a microphone when the equipment is or was in service.
3. The computer-implemented method of clauses 1 or 2, further comprising acquiring audio data included in the first audio recording using a microphone disposed within a wind filter, wherein the wind filter comprises a cover, and a stabilizer disposed within the cover.
4. The computer-implemented method of any of clauses 1-3, further comprising processing a second audio recording using at least one of one or more other trained machine learning models or one or more audio filtering techniques to generate the first audio recording.
5. The computer-implemented method of any of clauses 1-4, further comprising adding silence to an end of a second audio recording to generate the first audio recording.
6. The computer-implemented method of any of clauses 1-5, wherein the second trained machine learning model comprises a trained autoencoder model, and wherein detecting the anomaly comprises determining that a distance between (i) a first distribution of one or more errors that include an error between the third frequency representation and an output of the second trained machine learning model, and (ii) a predefined second distribution exceeds a predefined threshold.
7. The computer-implemented method of any of clauses 1-7, wherein the first trained machine learning model comprises a trained convolutional neural network.
8 The computer-implemented method of any of clauses 1-7, wherein the sound is produced by at least one of a track switch, an actuator, or a motor.
9. The computer-implemented method of any of clauses 1-8, further comprising layering one or more second audio recordings that include one or more voices on top of one or more third audio recordings that include one or more sounds produced by the equipment to generate one or more fourth audio recordings, and performing, based on the one or more second audio recordings, the one or more third audio recordings, and the one or more fourth audio recordings, one or more operations to train an untrained machine learning model to generate the first trained machine learning model.
10. The computer-implemented method of any of clauses 1-9, further comprising processing one or more fourth frequency representations of one or more second audio recordings using the first trained machine learning model to generate one or more fifth frequency representations, and performing, based on the one or more fifth frequency representations, one or more operations to train an untrained machine learning model to generate the second trained machine learning model.
11. In some embodiments, one or more non-transitory computer-readable media store instructions that, when executed by at least one processor, cause the at least one processor to perform the steps of processing a first frequency representation of a first audio recording using a first trained machine learning model to generate a second frequency representation of at least one voice and a third frequency representation of at least one sound produced by an equipment, detecting, using a second trained machine learning model, an anomaly based on the third frequency representation, and transmitting an alert to at least one computing device based on the anomaly.
12. The one or more non-transitory computer-readable media of clause 11, wherein the alert includes at least one of the first audio recording or a visualization of the anomaly.
13. The one or more non-transitory computer-readable media of clauses 11 or 12, wherein transmitting the alert comprises one of sending a text message to one or more notification devices, sending a push notification to one or more notification devices, sending a message to an application running on one or more notification devices, sending an email to a server, or sending a message to a server for storage in a database.
14. The one or more non-transitory computer-readable media of any of clauses 11-13, wherein the equipment is located within an amusement park attraction.
15. The one or more non-transitory computer-readable media of any of clauses 11-14, wherein the instructions, when executed by the at least one processor, further cause the at least one processor to perform the step of, in response to a signal from a sensor indicating that the equipment is or was in service, generating the first audio recording based on audio data acquired using a microphone when the equipment is or was in service.
16. The one or more non-transitory computer-readable media of any of clauses 11-15, wherein the instructions, when executed by the at least one processor, further cause the at least one processor to perform the step of acquiring audio data included in the first audio recording using a microphone disposed within a wind filter, wherein the wind filter comprises a cover, and a stabilizer disposed within the cover.
17. The one or more non-transitory computer-readable media of any of clauses 11-16, wherein the instructions, when executed by the at least one processor, further cause the at least one processor to perform the step of processing a second audio recording using at least one of one or more other trained machine learning models or one or more audio filtering techniques to generate the first audio recording.
18. The one or more non-transitory computer-readable media of any of clauses 11-17, wherein the instructions, when executed by the at least one processor, further cause the at least one processor to perform the step of adding silence to an end of a second audio recording to generate the first audio recording.
19. The one or more non-transitory computer-readable media of any of clauses 11-18, wherein the second trained machine learning model comprises a trained autoencoder model, and wherein detecting the anomaly comprises determining that a distance between (i) a first distribution of one or more errors that include an error between the third frequency representation and an output of the second trained machine learning model, and (ii) a predefined second distribution exceeds a predefined threshold.
20. In some embodiments, a system comprises a memory storing instructions, and one or more processors, that when executing the instructions, are configured to perform the steps of processing a first frequency representation of a first audio recording using a first trained machine learning model to generate a second frequency representation of at least one voice and a third frequency representation of at least one sound produced by an equipment, detecting, using a second trained machine learning model, an anomaly based on the third frequency representation, and transmitting an alert to at least one computing device based on the anomaly.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for detecting audio anomalies, the method comprising:
processing a first frequency representation of a first audio recording using a first trained machine learning model to generate a second frequency representation of at least one voice and a third frequency representation of at least one sound produced by an equipment;
detecting, using a second trained machine learning model, an anomaly based on the third frequency representation; and
transmitting an alert to at least one computing device based on the anomaly.

2. The computer-implemented method of claim 1, further comprising, in response to a signal from a sensor indicating that the equipment is or was in service, generating the first audio recording based on audio data acquired using a microphone when the equipment is or was in service.

3. The computer-implemented method of claim 1, further comprising acquiring audio data included in the first audio recording using a microphone disposed within a wind filter, wherein the wind filter comprises:
a cover; and
a stabilizer disposed within the cover.

4. The computer-implemented method of claim 1, further comprising processing a second audio recording using at least one of one or more other trained machine learning models or one or more audio filtering techniques to generate the first audio recording.

5. The computer-implemented method of claim 1, further comprising adding silence to an end of a second audio recording to generate the first audio recording.

6. The computer-implemented method of claim 1, wherein the second trained machine learning model comprises a trained autoencoder model, and wherein detecting the anomaly comprises determining that a distance between (i) a first distribution of one or more errors that include an error between the third frequency representation and an output of the second trained machine learning model, and (ii) a predefined second distribution exceeds a predefined threshold.

7. The computer-implemented method of claim 1, wherein the first trained machine learning model comprises a trained convolutional neural network.

8. The computer-implemented method of claim 1, wherein the sound is produced by at least one of a track switch, an actuator, or a motor.

9. The computer-implemented method of claim 1, further comprising:
layering one or more second audio recordings that include one or more voices on top of one or more third audio recordings that include one or more sounds produced by the equipment to generate one or more fourth audio recordings; and
performing, based on the one or more second audio recordings, the one or more third audio recordings, and the one or more fourth audio recordings, one or more operations to train an untrained machine learning model to generate the first trained machine learning model.

10. The computer-implemented method of claim 1, further comprising:
processing one or more fourth frequency representations of one or more second audio recordings using the first trained machine learning model to generate one or more fifth frequency representations; and
performing, based on the one or more fifth frequency representations, one or more operations to train an untrained machine learning model to generate the second trained machine learning model.

11. One or more non-transitory computer-readable media storing instructions that, when executed by at least one processor, cause the at least one processor to perform the steps of:
processing a first frequency representation of a first audio recording using a first trained machine learning model to generate a second frequency representation of at least one voice and a third frequency representation of at least one sound produced by an equipment;
detecting, using a second trained machine learning model, an anomaly based on the third frequency representation; and
transmitting an alert to at least one computing device based on the anomaly.

12. The one or more non-transitory computer-readable media of claim 11, wherein the alert includes at least one of the first audio recording or a visualization of the anomaly.

13. The one or more non-transitory computer-readable media of claim 11, wherein transmitting the alert comprises one of sending a text message to one or more notification devices, sending a push notification to one or more notification devices, sending a message to an application running on one or more notification devices, sending an email to a server, or sending a message to a server for storage in a database.

14. The one or more non-transitory computer-readable media of claim 11, wherein the equipment is located within an amusement park attraction.

15. The one or more non-transitory computer-readable media of claim 11, wherein the instructions, when executed by the at least one processor, further cause the at least one processor to perform the step of, in response to a signal from a sensor indicating that the equipment is or was in service, generating the first audio recording based on audio data acquired using a microphone when the equipment is or was in service.

16. The one or more non-transitory computer-readable media of claim 11, wherein the instructions, when executed by the at least one processor, further cause the at least one processor to perform the step of acquiring audio data included in the first audio recording using a microphone disposed within a wind filter, wherein the wind filter comprises:
a cover; and
a stabilizer disposed within the cover.

17. The one or more non-transitory computer-readable media of claim 11, wherein the instructions, when executed by the at least one processor, further cause the at least one processor to perform the step of processing a second audio recording using at least one of one or more other trained machine learning models or one or more audio filtering techniques to generate the first audio recording.

18. The one or more non-transitory computer-readable media of claim 11, wherein the instructions, when executed by the at least one processor, further cause the at least one processor to perform the step of adding silence to an end of a second audio recording to generate the first audio recording.

19. The one or more non-transitory computer-readable media of claim 11, wherein the second trained machine learning model comprises a trained autoencoder model, and wherein detecting the anomaly comprises determining that a distance between (i) a first distribution of one or more errors that include an error between the third frequency representation and an output of the second trained machine learning model, and (ii) a predefined second distribution exceeds a predefined threshold.

20. A system, comprising:
a memory storing instructions; and
one or more processors, that when executing the instructions, are configured to perform the steps of:
processing a first frequency representation of a first audio recording using a first trained machine learning model to generate a second frequency representation of at least one voice and a third frequency representation of at least one sound produced by an equipment,
detecting, using a second trained machine learning model, an anomaly based on the third frequency representation, and
transmitting an alert to at least one computing device based on the anomaly.
